(19) United States
(12) Patent Application Publication
(10) Pub. No.: US 2019/0050074 A1
(43) Pub. Date: Feb. 14, 2019

(54) ASSEMBLY TOOLS FOR PANEL AND TOUCH-SENSING SYSTEM

(71) Applicant: FlatFrog Laboratories AB, Lund (SE)

(72) Inventor: Alexander KOCOVSKI, Malmö (SE)

(21) Appl. No.: 16/077,242

(22) PCT Filed: Feb. 6, 2017
(86) PCT No.: PCT/SE2017/050102

§ 371 Date: Aug. 10, 2018

(30) Foreign Application Priority Data
Feb. 12, 2016 (SE) 1650184-3

(51) Int. Cl. G06F 3/041

(52) U.S. Cl. CPC G06F 3/041; G06F 2203/04103

(57) ABSTRACT

An assembly tool for mounting at least one component of a touch-sensing system to a panel is provided. The assembly tool comprises at least one fixture portion with a first side wall and at least a second side wall extending in a longitudinal direction of the assembly tool. The fixture portion is configured to hold the component in a predefined position therein. The first wall extends in a first transverse direction of the assembly tool and further than the second wall extends in the first transverse direction and has a guide surface configured to abut an edge of the panel and guide the position of the assembly tool relative to the edge of the panel. The assembly tool is also provided as a kit together with a carrier, and as a kit together with an applicator for applying a plastic strip to a panel.

### FIELD OF THE INVENTION

The present invention relates to an assembly tool for mounting at least one component of a touch-sensing system to a panel. More particularly, the assembly tool may provide a jig that is configured to hold the component as well as guide its position relative a front surface of a panel, such as a light transmissive panel. The assembly tool comprises at least one fixture portion with a first side wall and at least a second side wall extending in a longitudinal direction of the assembly tool. The fixture portion is configured to hold the component in a predefined position. Furthermore, the first wall extends in a first transverse direction of the assembly tool further than the second wall extends in the first transverse direction, and has a guide surface configured to abut an edge of the panel and guide the position of the assembly tool relative to the edge of the panel. The invention also relates to kits comprising the assembly tool and a carrier of the touch-sensing system and/or an applicator for a plastic strip of the touch-sensing system.

### BACKGROUND OF THE INVENTION

Touch-sensing systems (“touch systems”) are in widespread use in a variety of applications. Typically, the touch systems are actuated by a touching object such as a finger or stylus, either in direct contact, or through proximity (i.e. without contact), with a touch surface. Touch systems are for example used as touch pads of laptop computers, in control panels, and as overlays to displays on, e.g., hand held devices, such as mobile telephones, but also on larger devices and displays. A touch panel that is overlaid on or integrated in a display is also denoted a “touch screen”. Many other applications are known in the art.

There are numerous known techniques for providing touch sensitivity, e.g. by incorporating resistive wire grids, capacitive sensors, strain gauges, etc. into a touch panel. There are also various types of optical touch systems, which e.g. detect shadows cast by touching objects onto a touch surface, or detect light scattered off the point(s) of touching objects on a touch panel.

One specific type of optical touch system uses projection measurements of light that propagates on a plurality of propagation paths inside or above a light transmissive panel that defines a touch surface. The projection measurements thus quantify a property, e.g. power, of the light on the individual propagation paths, when the light has crossed the panel. The light may propagate inside the panel by total internal reflection (TIR) against the touch surface, such that objects on the touch surface causes the propagating light on one or more propagation paths to be attenuated, commonly denoted FTIR (Frustrated Total Internal Reflection). For touch determination, the projection measurements may be processed by simple triangulation, or by more advanced image reconstruction techniques that generate a two-dimensional distribution of disturbances on the touch surface, i.e. an “image” of everything on the touch surface that affects the measured property. Examples of such touch systems are found in U.S. Pat. No. 3,673,327, U.S. Pat. No. 4,254,333, U.S. Pat. No. 6,972,753, U.S. Pat. No. 7,432,893, US2006/0114237, US2007/0075648, WO2009/048365, US2009/0153519, WO2010/006882, WO2010/064983, WO2010/134865 and WO2012/105893.

Other systems use light that propagates above the surface. Similarly to the FTIR systems, touch determination may be based on techniques that determine touch from disturbances of the light travelling very close to the touch surface. This technology is commonly known as IR touch.

Common to the optical touch systems that utilizes light inside or above a light transmissive panel is that light transmitters and light sensors are arranged around the panel together with other electrical and optical components for coupling light into and out of the panel. The system is normally applied to surfaces of the panel using adhesive. The system is highly sensitive to correct alignment of the light transmissive system, including associated optical components, relative the light sensors, including their associated optical components, in order to provide appropriate propagation paths.

The opto-electrical components of the touch system are commonly manufactured separately from the panels to which they are later applied. Many times, the opto-electrical components are manually applied to the panel without using robots and other automated production techniques. In view of the sensitivity of correct alignment of the opto-electrical system around the panel, there is a great challenge for an operator to manually align the touch system on the panel for accurate and precise generation of propagation paths and, thus, accurate determination of touch location on the surface of the panel. Also, aligning the components on the panel is time consuming.

The present invention addresses a widely recognized need for efficient alignment of one or several components of a touch-sensing system relative a panel, and that provides for improved efficacy and/or accurate touch-sensing system.

### SUMMARY OF THE INVENTION

Accordingly, embodiments of the present invention preferably seek to mitigate, alleviate or eliminate one or more deficiencies, disadvantages or issues in the art, such as the above-identified, singly or in any combination by providing an assembly tool, and a kit of components comprising such an assembly tool, for mounting at least one component of a touch-sensing system to a panel.

The invention is defined by the appended claims.

The disclosed approach introduces an assembly tool for mounting at least one component of a touch-sensing system to a panel. The assembly tool comprises at least one fixture portion with a first side wall and at least a second side wall extending in a longitudinal direction of the assembly tool and being configured to hold the component in the fixture portion. The first wall extends in a first transverse direction of the assembly tool further than the second wall extends in the first transverse direction and has a guide surface configured to abut an edge of the panel and guide the position of the assembly tool relative to the edge of the panel.

At least one of the first side wall and the second side wall may comprises at least one connecting element that extends differently in a second transverse direction of the assembly tool than the et least one of the first side wall and the second side wall. The connecting element may comprise at least one of a protrusion and a recess of a snap-fit connection.

The assembly tool may comprise a bottom wall extending in a second transverse direction of the assembly tool and between the first side wall and the second side wall. A support structure may be attached to the second side wall and may extend in the second transverse direction and substantially parallel to the bottom wall. The support structure may be configured to abut a top surface of the panel.

The assembly tool may further comprise a compressible cushion attached to the support structure and configured to abut the top surface of the panel.

The first side wall may be substantially planar and may be provided in a single plane in the first transverse direction.

At least one of the first side wall and the second side wall may comprise a slot.

The assembly tool may comprise a third side wall extending in the first transverse direction and substantially perpendicularly to the first side wall. The third side wall may be arranged at a distance from an end of the fixture portion.

The assembly tool may be double sided and the at least one fixture portion may include a first fixture portion and a second fixture portion on each side of the first side wall. The assembly tool may further comprise a fourth side wall corresponding to the third side wall. The third side wall may be arranged at a first distance from an end of the first fixture portion. The fourth side wall may be arranged at a second distance from an end of the second fixture portion and at the same side of the assembly tool as the third side wall.

Embodiments may comprise a kit comprising the assembly tool and a carrier for at least one component of a touch-sensing system. The carrier may comprise an elongated profile having a first substantially flat surface for receiving an adhesive and a second surface spaced apart from the first surface. A space may be provided between the first substantially flat surface and the second surface. The first surface may comprise at least one slot.

The carrier may comprise at least one of a protrusion and a recess in opposing side surfaces extending between the first substantially flat surface and the second surface. The assembly tool may comprise the other of a protrusion and a recess in the first wall and the second wall, which are arranged to mate with the at least one of a protrusion and a recess in the first substantially flat surface and the second surface of the carrier.

In some embodiments, the carrier is applied to the panel without using the assembly tool.

Embodiments comprise a kit comprising the assembly tool and at least one applicator for applying a strip to a surface of a panel. The applicator comprises a guide with opposing surfaces and at least one transverse surface extending therebetween, wherein at least one slot is provided in the transverse surface. It may also comprise a guide surface arranged to abut an edge of the panel to align the strip relative the edge of the panel.

The at least one slot in the transverse surface of the applicator may include a first slot and a second slot. The first slot and the second slot may be separated by a distance in the longitudinal direction of the applicator. The first slot may form an exit of a first channel for the plastic strip. The second slot may provide an exit of a second channel for a cover over an adhesive of the plastic strip. An entry to the first channel and an entry to the second channel may be provided at one end of the applicator. The entries may be separated by a distance forming an edge for separating the cover from the plastic strip.

The applicator may comprise at least one flexible member provided in at least one of the opposing surfaces of the applicator. The flexible member may extend into the space between the opposing surfaces to apply a pressure to the plastic strip when received therein.

The applicator may comprise a groove on a surface opposite to the transverse surface. The groove may be configured for receiving at least one finger of an operator. The applicator may comprise a holder for a roll of the plastic strip.

Embodiments of the invention provide tools for efficient alignment of one or several components of a touch-sensing system relative a panel. This in turn provide for improved efficacy and/or accuracy of the touch-sensing system including the components. It also provides for reduced assembly time and cost compared to applying the components to the panel manually. Hence, the tools provide for improved efficiency while the accuracy of the alignment is also improved.

The term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

These and other aspects, features and advantages of which embodiments of the invention are capable of, will be apparent and elucidated from the following description of embodiments of the present invention, reference being made to the accompanying drawings, in which

FIGS. 1-3 are perspective views of embodiments of the assembly tool;

FIG. 4 is a perspective view of an embodiment of a double sided assembly tool;

FIGS. 5-6 are perspective views of embodiments of a kit comprising the assembly tool and a carrier;

FIG. 7 is a perspective view of the assembly tool and the carrier positioned relative an edge of a panel;

FIGS. 8-10 are perspective views of an applicator for applying a strip to a panel;

FIG. 11 is a a perspective view of an applicator for applying a strip to a panel;

FIGS. 12a and 12c are perspective views of applicators for applying strips to the panel;

FIG. 12b is a perspective view of an alignment tool to be used with the applicators of FIGS. 12a and 12c; and

FIG. 13 is a side view of components arranged relative a panel using tools according to embodiments.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

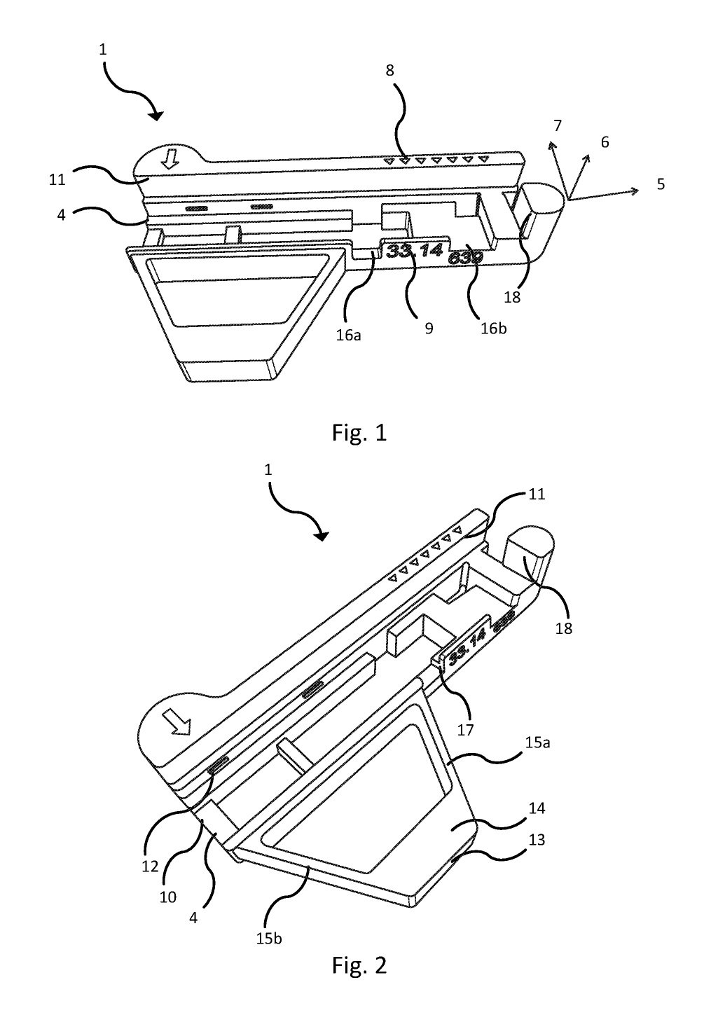

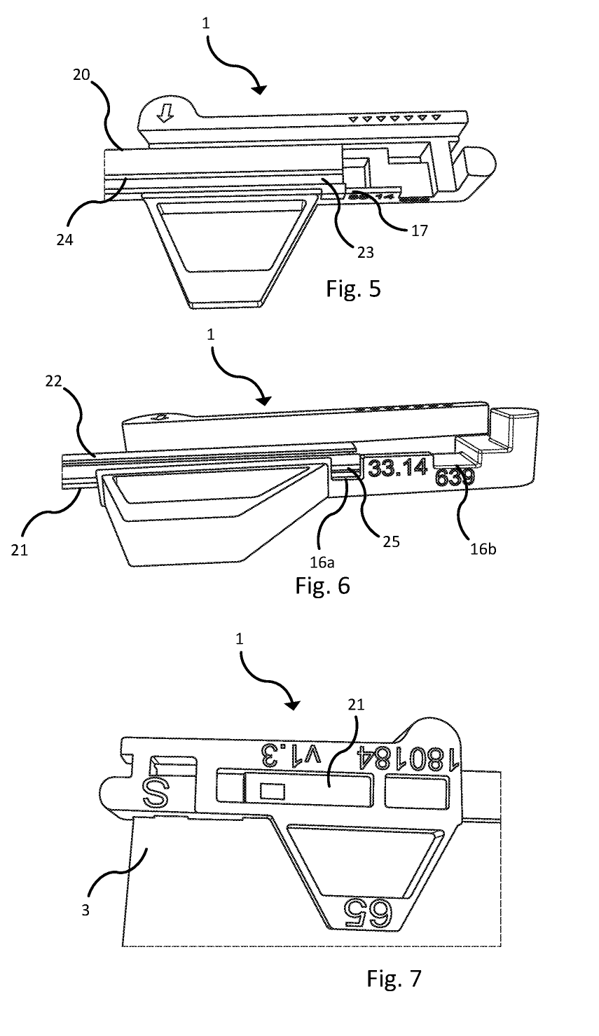

FIGS. 1-2 illustrate embodiments of an assembly tool 1 for mounting at least one component 2 (FIGS. 5-7) of a touch-sensing system to a panel 3 (FIG. 7). The touch-sensing system may be an electro-optical touch-sensing system including various electronic and optical components that are arranged relative one or several surfaces of the panel 3. The panel 3 may comprise a light transmissive panel. The touch-sensing system is not subject to this application, and reference is made to the systems mentioned above for more details. The component 2 of the touch-sensing system may comprise a component for carrying or housing the electro-optical components, as will be described in more detail below.

The assembly tool 1 may form a jig that is used to control the location of the component 2 of the touch-sensing system relative the panel 3 before it is fixed to the panel, such as using an adhesive or adhesive film. The assembly tool 1 may also be configured to hold or fix the component 2 of the touch-sensing system before it is applied in the correct location to the panel 3. Hence, the assembly tool 1 may function both for temporarily holding the component 2 of the touch-sensing system and guiding its position relative the panel 3. Hence, the assembly tool 1 provides repeatability and accuracy in the assembly process of the component 2 and the panel 3, wherein efficiency and accuracy of the touch-sensing system is achieved. Features of embodiments of the invention that will be described in the following contribute to the repeatability, efficiency and accuracy in the assembly process and thus accuracy of the touch-sensing system.

Returning to FIGS. 1-2, the assembly tool 1 comprises at least one fixture portion 4 configured to hold the component 2 in a predefined position therein. The assembly tool 1 extends in a longitudinal direction 5, a first transverse direction 6, and a second transverse direction 7. The first transverse direction 6 is perpendicular to the longitudinal direction 5, and the second transverse direction 7 is perpendicular to the longitudinal direction 5 and the first transverse direction 6. The fixture portion 4 extends in the longitudinal direction of the assembly tool 1.

In this embodiment, the assembly tool 1 and the fixture portion 4 comprise a first side wall 8 and at least a second side wall 9. The first side wall 8 and the second side wall 9 extend in the longitudinal direction 5 of the assembly tool 1. A bottom wall or spacing structure 10 may extend between the first side wall 8 and the second side wall 9, whereby the side walls 8, 9 are spaced apart a predefined distance. Also, the transverse surface 10 may provide a rail for the component 2. This distance may substantially correspond to or be slightly smaller than a width of the component 2 of the touch-sensing system, which may be arranged and temporarily fixed between the side walls 8, 9. The side walls 8-9 may provide a press-fit connection for the component 2. Hence, the side walls 8, 9 may be arranged to hold the component 2 of the touch-sensing system when received therein.

Furthermore, the first wall 8 extends in the first transverse direction 6 of the assembly tool 1 further than the second wall 9 extends in the first transverse direction. Hence, the first side wall 8 and the second side wall 9 have different extents on the same side of the assembly 1, i.e. on the side wherein the fixture portion 4 is provided. The first wall 8 comprises a guide surface 11 configured to abut an edge of the panel 3 when the assembly tool 1 is correctly aligned against the panel 3. The guide surface 11 may be an upper or outer portion of the first side wall 8 which is exposed, i.e. it is not shielded or covered, by the component 2 when it is correctly aligned in the fixture portion 4.

The guide surface 11 is arranged to guide the position of the assembly tool 1 relative to the edge of the panel 3. The guide surface 11 may be substantially straight or planar in the longitudinal direction of the assembly tool 1. The guide surface 11 may be provided at a right angle relative the bottom wall or spacing structure 10. Furthermore, the guide surface 11 may be formed by a plurality of protrusions or bosses extending from the first side wall 8 and having a tip aligned in the longitudinal direction of the assembly tool 1, such as arranged in a straight line or in a single plane, whereby each tip abuts the edge of the panel 3 when aligned with panel 3. When the guide surface 11, and thus the assembly tool 1, is aligned with the edge of the panel 3, the location of the component 2 of the touch-sensing system is correctly aligned relative the panel 3, such as relative a back surface of the panel 3. Alignment of the assembly tool 1 relative the panel 3 is illustrated in FIG. 7 and will be further discussed below.

As is illustrated in FIGS. 1-2, at least one of the first side wall 8 and the second side wall 9 comprises at least one connecting element 12. The connecting element 12 may extend in the second transverse direction 8 and differently than at least one of the first side wall 8 and the second side wall 9. Hence the connecting element 12 may comprises at least one of a protrusion and a recess of a snap-fit connection. The connecting element 12 may be received in a corresponding connecting element of the component 2 having a complementary shape, i.e. the other of a protrusion and recess. Hence, the connecting element 12 protrudes from and/or extends into the first side wall 8 and/or the second side wall 9. The connecting element 12 is arranged in the fixture portion 4 in order to hold the component 2 more stable and/or aligned in the fixture portion 4, wherein improved repeatability, efficiency and accuracy of the assembly of the component 2 and the panel 3 is provided for.

In some embodiments, each of the first side wall 8 and the second side wall 9 comprises connecting elements 12. Furthermore, a single elongated connecting element 12 may be provided at each of the first side wall 8 and the second side wall 9. Alternatively, a plurality of connecting elements 12 may be provided at each of the first side wall 8 and the second side wall 9, such as at each end of the fixture portion 4 in the longitudinal direction 5 of the assembly tool 1. The distance, measured perpendicularly to the first side wall 8 or the second side wall 9, between connecting elements on the first side wall 8 and the second side wall 9 is smaller than a maximum width of the component 2. The perpendicular distance may be larger than the minimum distance, also measured perpendicularly, between connecting elements on the component 2, whereby a snap fit connection is provided for. Hence, a stable and accurate connection between the component 2 and the assembly tool 1 is provided for.

As is illustrated in FIGS. 1-2 and mentioned above, the assembly tool 1 may comprise the bottom wall or spacing structure 10. The bottom wall or spacing structure 10 extends in the second transverse direction of the assembly tool 1 and between the first side wall 8 and the second side wall 9. Hence, the bottom wall or spacing structure 10 spaces the first side wall 8 from the second side wall 9 a distance such that the component 2 may be received in the fixture portion 1. The bottom wall or support structure 10 may extend in the first transverse direction 6 such that it provides a support surface for the component 2, whereby that the component 2 abuts the bottom wall or support structure 10 when correctly arranged in the fixture portion 4. Hence, a stable and accurate connection between the component 2 and the assembly tool 1 is provided for.

As is illustrated in FIGS. 1-2, a support structure 13 may be attached to the second side wall 9. The support structure 13 extends in the second transverse direction. The support structure 13, such as a top surface 14 thereof, faces in the first transverse direction 6 and may be arranged substantially parallel to the bottom wall or spacing structure 10. The support structure 13 is configured to abut a top surface of the panel 3 into which the component 2 is to be applied. The distance between the top surface 14 of the support structure 13 and the bottom wall or spacing structure 10 in the second transverse direction 7 may substantially correspond to the thickness of the component 2 in this direction. Hence, when the assembly tool 1 is correctly aligned against the edge of the panel 3, the component 2 is parallel with the top surface of the panel 3, and the support structure 13 abuts the top surface of the panel 3. Hence, the assembly tool 1 is more stable. The support structure 13 may be attached to the second wall 9 by at least one leg 15a, 15b. Hence, the support structure may be spaced from the fixture portion 4, such as 2-5 cm, in the second transverse direction, whereby a more accurate alignment, i.e. parallel alignment, of the component 2 with the front surface panel 3 is provided for.

In some embodiments, a compressible cushion is attached to the support structure 13, such as to the top surface 14, and configured to abut the top surface of the panel 3. The compressible cushion has a compressed state and a relaxed state. In the relaxed state, the distance between the bottom wall or spacing structure 10 and an outer surface of the cushion that faces in the second transverse direction 7 is larger than the height of the component 2 in this direction. Hence, when the assembly tool 1 is correctly aligned against the edge and the front surface of the panel 3, an adhesive on a surface of the component 2 that faces the front surface of the panel 3 will be spaced from the panel 3. In the compressed state, the distance between the bottom wall or spacing structure 10 and the outer surface of the cushion can be substantially equal to or smaller than the height of the component 2. Hence, the cushion can be compressed such that the adhesive abuts the surface of the panel 3 and a pressure can be applied to the component 2 to form a firm bond between the component 2 and the panel 3. This provides for avoidance of pre-mature connection between the adhesive and the panel 3 before the assembly tool 1 is correctly aligned with the panel 3, and thus for improved repeatability, efficiency, and accuracy.

In some embodiments, the first side wall 8 is substantially planar and provided in a single plane extending in the longitudinal and first transverse direction 6. This provides for providing a side of the fixture portion 4 and the guide surface 11 in a single plane. Hence, during assembly, the component 2 and the panel 3 are pressed against the same surface during application. This provides for that tolerances of the assembly tool 1 do not affect the relative tolerances between the panel 3 and the component 2. In other embodiments, a side wall of the fixture portion 4 and the guide surface 11 are provided in multiple planes that are parallel but spaced apart.

As is illustrated in FIGS. 1-4, at least one of the first side wall 8 and the second side wall 9 comprise a slot 16a, 16b. In the illustrated embodiments, a first slot 16a and a second slot 16b are provided in the second side wall 9. The first slot 16a is arranged to provide an inspection window into the fixture portion 4. This provides for visually inspecting that the component 2 is correctly aligned in the fixture portion 4, such as a surface of the component 2 abutting the bottom wall or spacing structure 10. Hence, the first slot 16a may extend from the bottom wall or spacing structure and in the first transverse direction 7. The second slot 16b may provide an inspection window for visually inspecting that an opto-electrical component received in component 2 is correctly aligned in the assembly tool 1. When the assembly tool 1 is correctly aligned relative the panel 3, the opto-electrical component will also be correctly aligned relative the panel 3.

A stop member 17 may be provided at a distance from an end of the fixture portion 4. The stop member 17 extends from the bottom wall or spacing structure 10 in the first transverse direction 6, which may be less that the extent of the second wall 9 in the first transverse direction 6. The stop member 17 provides a stop for component 2 in the longitudinal direction 5. An opto-electrical component received in component 2 may pass over the stop member 17. This provides for the opto-electrical component to extend further into the fixture portion 4 than component 2. The stop member 17 may be provided between the first slot 16a and the second slot 16b, such as at an edge of the first slot 16a located towards the second slot 16b, whereby it may be visually inspected that the component 2 is fully inserted in the longitudinal direction 5, and correct alignment and accuracy are provided for.

As is illustrated in FIGS. 1-2, the assembly tool 1 may comprise a third side wall 18 extending in the first transverse direction 6 and substantially perpendicularly to the first side wall 8, i.e. to the guide surface 11 of the first side wall 8. The third side wall 18 may be arranged at a distance from an end of the fixture portion 4 and/or the stop member 17. The third side wall 18 may be configured to abut another edge of the panel 3, which is perpendicular to the edge of the panel 3 against which the first side wall 8, i.e. the guide surface 11, is configured to abut. This provides for aligning the component 2 at a predefined distance from the other edge of the panel 3, i.e. from the corner, whereby accuracy is provided for. This embodiment may be used as a starter tool, wherein application of the component is made relative a pre-defined corner of the panel and at pre-defined distance from the corner. In other embodiments, the assembly tool 1 does not comprise any third side wall, whereby the component 2 may extend through the assembly tool 1 in the longitudinal direction 5. This provides for attaching the assembly tool 1 to a centre or centre portion of the component 2, between ends of the component 2. This provides for aligning the component between two corners of the panel 3, which may be required for larger panels. Such a tool not comprising a third side wall may also be used as an end tool, wherein application of the component at an end position does not need to be guided relative a corner of the panel. In some embodiments, a starter tool having the third side wall 18 may be attached at one end of the component 2, and an end tool not having the third side wall may be attached at the opposing end of the component 2. The position of the component relative the panel is guided relative the corner at the starter tool.

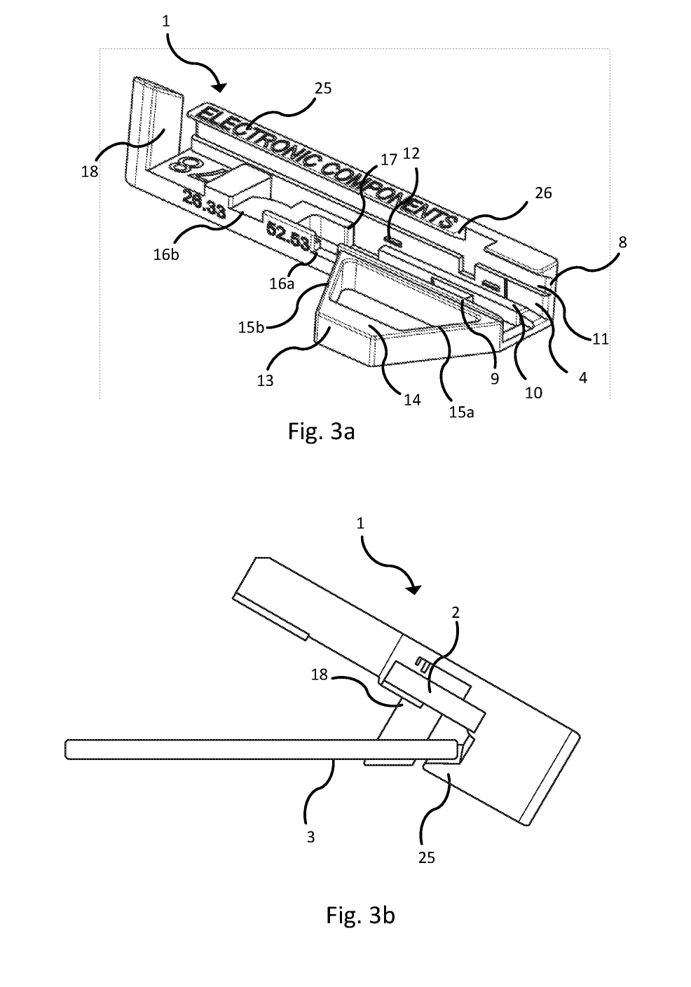

FIGS. 3a-3b illustrate an embodiment of the assembly tool 1, wherein the same features as in the embodiments of FIGS. 1-2 are denoted with the same reference numerals and will not be repeated with regard to the embodiment of FIG. 3. In this embodiment, a ledge 25 extends from the first side wall 8 in a plane that is non-parallel and angled less than 90 degrees relative the bottom wall or spacing structure 10. The ledge 25 extends over the bottom wall or spacing structure 10 such that the component 2 may be received therebetween. The ledge 25 has at least one inspection window 26 for verifying that the panel 3 is correctly aligned relative the assembly tool 1. As is illustrated in FIG. 3b, in order to apply the component 2 to the panel 3, the surface of the ledge 25 facing the component 2 is first aligned parallel relative to a first surface of the panel 1, and the first wall 8 is aligned relative the edge of the panel 3. The third side wall 18, if present, is aligned relative another edge of the panel 3. Then, the assembly tool 1, and the component 2 are angled towards an opposing second surface of the panel 3. This assists in aligning the first wall 8 correctly against the edge before the component 2 is applied to the opposing surface. Correct alignment can be verified by visual inspection through inspection window 26.

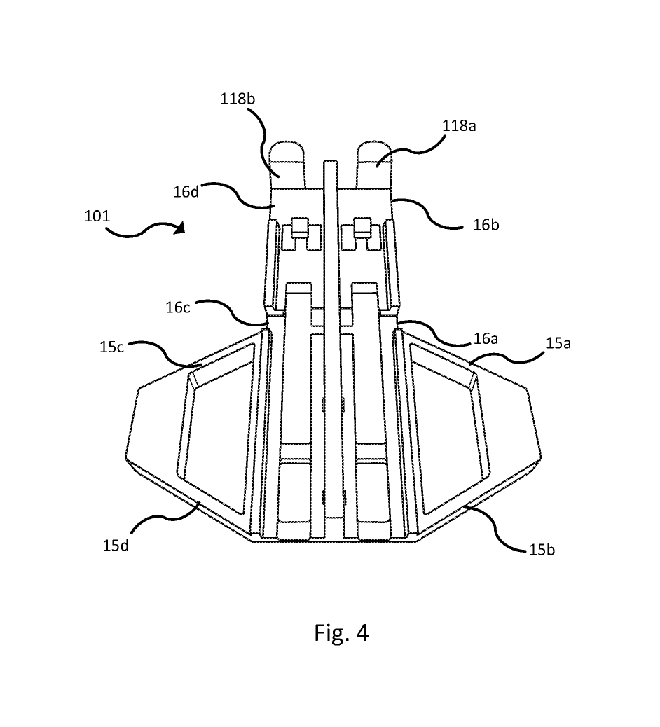

FIG. 4 illustrates an embodiment wherein the assembly tool 101 is double sided. The fixture portion of this embodiment includes a first fixture portion 104a and a second fixture portion 104b on each side of the first side wall 108. Embodiments of the double sided assembly tool 101 may comprise the features of the single sided assembly tools illustrated in FIGS. 1-3 and 5-7. These features will not be repeated with regard to the double sided assembly tool 101. Instead, these features are represented with reference numerals incremented by 100 compared to the same feature of the single sided assembly tool 1. The design of each side of the double sided assembly tool 101 may mirror the other side. Hence, the “a” of a reference numeral denotes a first of a particular feature, and “b” denotes a second of the same feature, except for a third leg 115c, which corresponds to the first leg 115a, a fourth leg 115d, which corresponds to the second leg 115b, a third slot 116c, which corresponds to the first slot 116a, and a fourth slot 116d, which corresponds to the second slot 116b.

The double sided assembly tool 101 may comprise a fourth side wall 118b corresponding to the third side wall 118a. Hence, the fourth side wall 118b may be substantially perpendicular to the second guide surface 111b. The third side wall 118a may be arranged at a first distance from an end of the first fixture portion 104a. The fourth side wall 118b may be arranged at a second distance from an end of the second fixture portion 104b and at the same side of the assembly tool 101 as the third side wall. This provides for a single assembly tool 101 that can be used to align the component 2 relative any corner of the panel 3. Hence, the tool is more flexible and efficient. If a single sided assembly tool 1 is provided, the third side wall 18 have to be provided at different ends of the assembly tool 1 in order to guide at opposite corners at the same edge of the panel 3. The first distance and the second distance may be identical or different, depending on the same or different spacing of the component 2 from the corners of the panel 3. In some embodiments, the double sided assembly tool 101 does not comprise the third wall 118a and/or the fourth side wall 118b. This provides for using the double sided assembly tool 101 as an end tool at any corner of the panel without the third wall 118a and/or the fourth side wall 118b interfering with the corner.

FIGS. 5-7 illustrate an embodiment of the component comprising a carrier 20, which may be received in the fixture portion 4 of the assembly tool 1. The carrier 20 is accurately positioned in the assembly tool 1 for alignment with the panel 3 in FIGS. 5-7. FIGS. 5-6 illustrate that the carrier 20 is inserted to and abuts the stop member 17. FIG. 7 illustrates that a surface 21 of the carrier 20 faces the bottom wall or spacing structure 10. In this embodiment, the surface 21 of the carrier 20 abuts the bottom wall or spacing structure 10. In other embodiments, the carrier 20 is spaced from the bottom wall or spacing structure 10 while being accurately held in the fixture portion 4.

The carrier 20 may be configured to receive at least one component of a touch-sensing system, such as electro-optical components arranged on one or several PCBs. The carrier 20 may comprise a profile, such as an aluminum, other metallic or plastic, profile. The carrier 20 may comprises an elongated profile having a first substantially flat surface 22 for receiving an adhesive and a second surface, such as surface 21, spaced apart from the first surface 22. A space 23 may be provided between the first substantially flat surface 22 and the second surface 21. The space 23 may be configured to receive the component of the touch-sensing system, such as the electro-optical components. The first surface 22 may comprises at least one slot 24. A signal, such as a light signal, may be transmitted through the slot 23 of the carrier 20. Hence, the carrier 20 may be arranged in the fixture portion 4 such that the first surface 22 of the carrier 20 faces a surface of the panel 3 when aligned with the assembly tool 1. The first surface 22 may be configured to receive an adhesive, such as a double sided adhesive film, such as 5-15 mm wide.

As is illustrated in FIG. 6, some embodiments of the carrier 20 comprise a connecting element 25, that may be formed as at least one of a protrusion and a recess in opposing side surfaces extending between the first substantially flat surface 21 and the second surface 22. The assembly tool 1 comprises the connecting element 17 as described above, that may be formed as the other of a protrusion and a recess in the first wall 8 and the second wall 9. The connecting element 25 of the carrier 20 is arranged to mate with the connecting element 17 of the assembly tool 1, such as in order to form a snap fit or form fit connection. In the illustrated embodiment, the connecting element 25 of the carrier 20 is a single recess extending along the length of the carrier 20 in the longitudinal direction 5, in which one or several protrusions of the assembly tool 1 may be received. Hence, the carrier 20 may be slid into the fixture portion 4 from an end of the assembly tool 1, or snapped in place from the top of the assembly tool 1, whereby flexibility is provided for. In some embodiments, the carrier 20 is provided separately from the assembly tool 1 and can be arranged relative the panel 3 by other means.

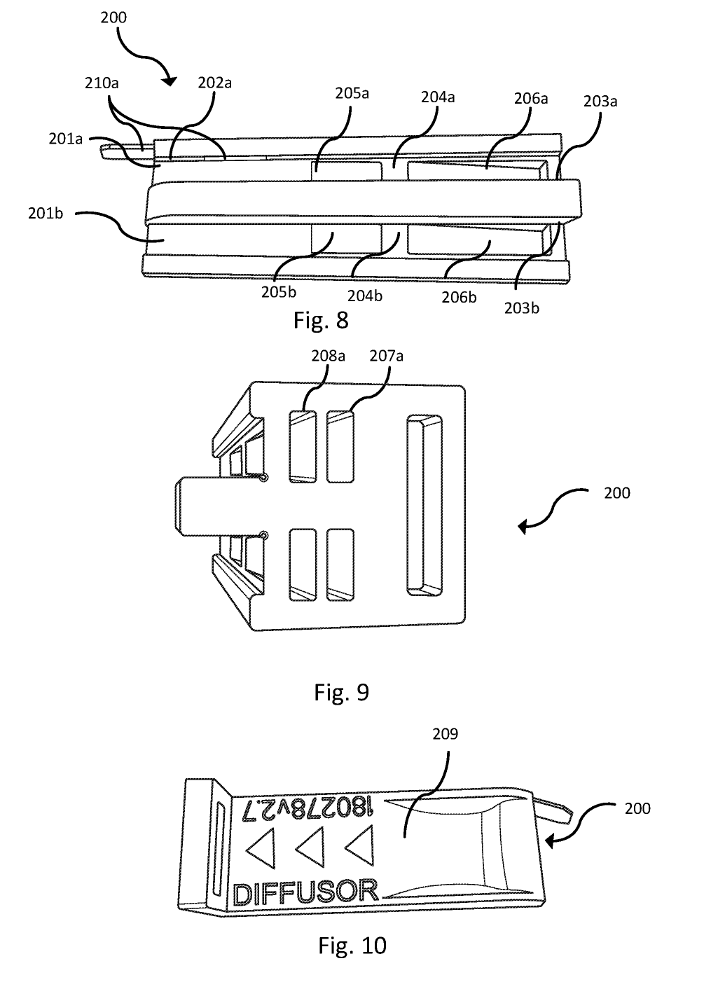

FIGS. 8-10 illustrate an applicator 200 for applying a strip to a surface, such as to the front surface of the panel 3. The strip may form a light transmissive element configured to transfer or direct light, such as a diffuser/sealing window/other plastic parts for application to a light transmissive panel. The strip may be made of PET (polyethylene terephthalate). The applicator 200 may be configured to align the strip to a surface of the panel 3 opposite to the component 2, e.g. such that light from an opto-electrical component is accurately transferred and/or directed through the panel 3, which may be a light transmissive panel. Hence, the applicator 200 and assembly tool 1, 101 may be provided as a kit that is configured to align respective components of a touch-sensing system at respective distances from an edge and/or a corner of the panel 3 for accurate sensing of touches on the panel 3. Light may emitted by an electro-optical component arranged on one side of the panel 3, and be directed by the strip on the other side of the panel 3 and opposite to the electro-optical component.

The applicator 200 illustrated in FIGS. 8-10 is double sided, i.e. the strip may be applied from left to right, or vice versa by applying the strip in a first guide 201a, or a second guide 201b. The applicator will be described with regard to one side of the applicator, corresponding features on each side of the applicator 200 is denoted with the same reference numeral followed by “a” and “b”, respectively. Reference will only be made to side “a” in the following. Other embodiments comprise at least one single sided applicator.

The guide 201a comprises opposing surfaces 202a, 203a and at least one transverse surface 204a extending therebetween. The opposing surfaces 202a, 203a and the transverse surface 204a may form the guide along which the strip is guided. The guide 201a is substantially straight, such that the strip may be received and guided therein. One of the opposing surfaces 202a, 203a extends further in a transverse direction of the applicator 200 to provide a guide surface configured to abut the edge of the panel 3, similar to the assembly tool 1, 101, as described above. Hence, the strip is applied a uniform defined distance from the edge, or at the edge, along the entire edge where the strip is applied. Hence, an accurate application of the strip is provided for. The opposing surfaces 202a, 203a, may be configured as the first side wall 8 and the second side wall 9 as has been described above with regard to guiding the applicator 201 relative the edge of the panel 3. This functionality will not be described again with regard to the applicator 200 that may use the same concept as described above in this regard.

In some embodiments, such as is illustrated in FIGS. 8-10, a first slot 205a and a second slot 206a are provided in the transverse surface 204a. The first slot 205a and the second slot 206a are separated by a distance in the longitudinal direction of the applicator 200. The first slot 205a may be provided substantially in the centre of the guide 201a. The second slot 206a may be provided at one end of the applicator 200, which may be at the end located at the direction of application of the strip to the panel 3. The first slot 205a forms an exit of a first channel for the plastic strip. The strip is introduced into the guide 201a through the first channel. The second slot 206a provides an exit of a second channel for a cover over an adhesive of the plastic strip. An entry 207a to the first channel and an entry 208a to the second channel are provided at one end of the applicator, which is the end of the direction of application of the plastic strip. The entries 207a, 208a may be separated by a distance forming an edge for separating the cover from the plastic strip. The edge may be wedge shaped. When the strip is applied to the applicator 200, the end of the plastic strip with the adhesive is introduced into the first channel, and the end of the cover, which is separated from the adhesive, is introduced into the second channel. The strip extends through the first channel to the first slot 205a and is introduced into the guide 201a, where the adhesive is exposed to the front surface of the panel 3. Applying a pressure to a side of the applicator opposite the guide 201a presses the strip towards the front surface of the panel 3, and the strip is fixed to the panel 3. The strip may alternatively be fixed by pressing directly onto the strip and only be aligned using the applicator 200. The cover extends through the second channel and exists at the second exit formed by the second slot 206a. The cover is returned through the guide 201a towards the same end of the applicator as the strip is inserted. The cover forms a loop around a bar formed by the end of the transverse surface 204a and the second channel. Pulling the cover in the direction of application of the strip separates the cover from the adhesive and may pull the entire applicator 200 in the direction of application of the strip. At the same time, a pressure may be applied to the surface opposite to the transverse surface 204a and/or directly to the the strip, whereby the strip is fixed to the panel 3.

As can be seen in FIG. 10, a groove 209 may be provided in the surface opposite to the transverse surface 204a. The groove 209 may be configured for receiving at least one finger. The groove 209 may be used to apply a pressure towards the front surface of the panel 3 at the same time as the applicator 200 is pushed in the direction of application and towards the edge of the panel 3, wherein efficient and accurate alignment of the strip to the front surface of the panel 3 is provided for.

As is illustrated in FIG. 8, at least one flexible member 210a is provided in at least one of the opposing surfaces 202a, 203a of the guide 201a. The flexible member 210a extends into the space between the opposing surfaces 202a, 203a and is configured to apply a pressure to the plastic strip when received therein. Hence, a perpendicular distance between the outermost portion of the flexible member 210a in an uncompressed state and the opposite surface 202a, 203a is slightly smaller than the width of the strip. When the strip passes the flexible member, a pressure is applied to the strip pressing it towards and aligning it with the opposing surface 202a, 203a. If the opposing surface 202a, 203a also forms the guide surface for abutment to the edge of the panel 3, the strip will be aligned to this surface, and thus also with the edge of the panel 3. The flexible member 210a may form a leaf spring. The flexible member 210a may be received in a pocket in one of the opposing surfaces 202a, 203a, which has a slot into the guide 201a, though which the flexible member 110a may extend. The flexible member 210a may extend over the transverse surface 204a. The flexible member 210a may flex into the pocket in the compressed state. The pocket may have an entry at one end of the applicator 200, through which the flexible member 211a may extend even when fully seated, whereby the flexible member 211a may be provided separately from the application 200, which provides for flexibility of producing the application 200.

In some embodiments, the applicator 200 comprises a holder for a roll of the plastic strip, which is arranged at the same end of the applicator as the entries 207a, 208a.

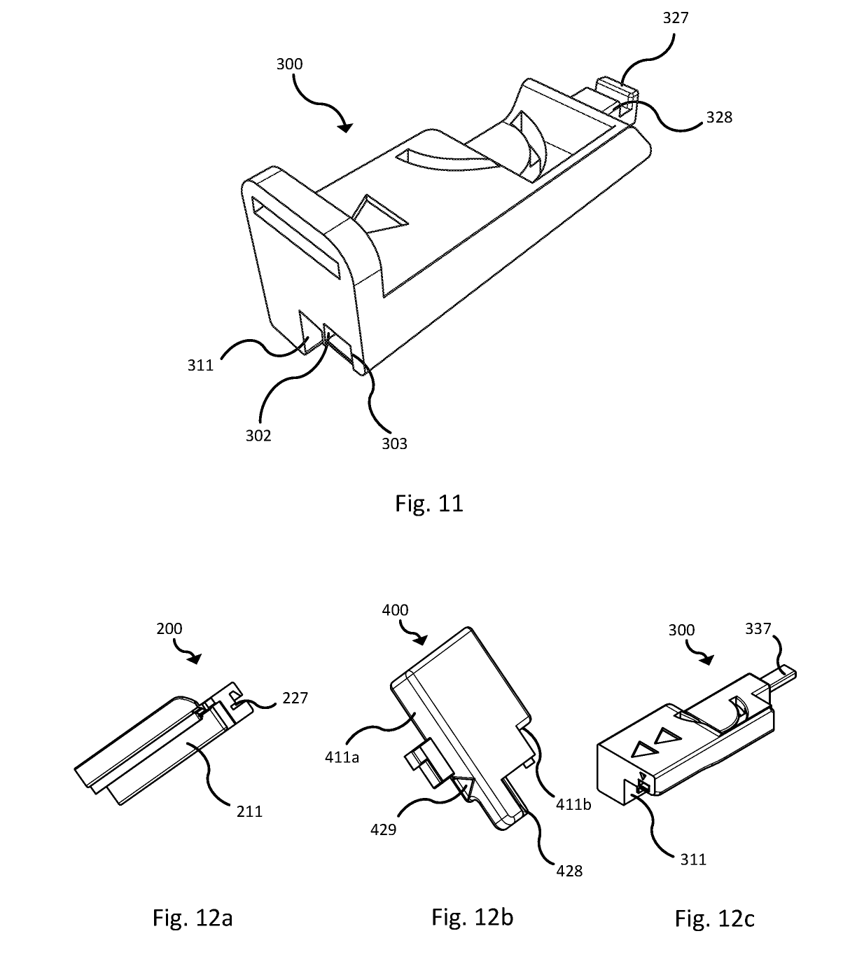

FIG. 11 illustrates an applicator 300 for applying a strip to a surface, such as to the front surface of the panel 3. The applicator 300 may be used for applying a strip, such as a sealing to prevent dust and particles to reach the opto-electrical system from the front side of the panel 3. This applicator 300 may be used in the same way as the applicator 200 described with regard to FIGS. 8-10. A difference is that the tool comprises opposing surfaces 302, 303, which aligns the strip in the applicator 300. A guide surface 311 is parallel with and spaced apart from the opposing surfaces 302, 303. This provides for applying the strip to the panel 3 a predefined distance from the edge of the panel, which is larger than the distance at which a strip is applied using applicator 200 in FIGS. 8-10. Hence, the applicators 200, 300 can be included in a kit to apply strips parallel at separate distances from the edge of the panel. Other feature, such as introducing the strip and separating the cover from the strip described with regard to the embodiment of FIGS. 8-10 are applicable to the embodiment of FIG. 11.

Furthermore, the applicator 300 may have an alignment member 327 at one end of the applicator 300. The strip may be applied in the applicator 300 a pre-defined distance from the end surface of the alignment member 327. When applying the strip to the panel 3, alignment member may be positioned at the corner, whereby the end of the strip is positioned a pre-defined distance from the corner. A recess 328 in the alignment member 327 may indicate the accurate position of the applicator 300 relative a corner of the panel. The recess may be parallel to an edge that is transverse to the edge along which the strip is to be applied. Hence, accuracy is provided for. Such an alignment member may also be provided in applicator 200 of the embodiments of FIGS. 8-10.

FIGS. 12a-12c illustrates embodiments of an applicator 200 for a first strip, an applicator 300 for a second strip, and an alignment tool 400. Features of applicator 200 described above with regard to FIGS. 8-10 are applicable also to the applicator of FIG. 12a. Similarly, features of applicator 300 described above with regard to FIG. 11 are applicable also to the applicator of FIG. 12c.

Each of applicator 200 of FIG. 12a and applicator 300 of FIG. 12c comprises an alignment member 227, 327, arranged as described above. The cross-section shapes of each of the alignment members 227, 337 taken transverse to the longitudinal axis of the applicators 200, 300, are different. For example, the cross-sectional shape of alignment member 200 may be T-shaped or rectangular. The cross-sectional shape of applicator 300 may be triangular or hexagonal.

The alignment tool 400 may comprise recesses 428, 429 which have shapes that are complementary to the cross sectional shapes of each alignment member 227, 337. Each recess 428, 429 may be provided at separate guide surfaces 411a, 411b of the alignment tool. The alignment members 227, 327 may fit in the recesses 428, 429 in a slit fit or a friction fit. When the alignment tool 400 is connected to the applicator 200, 300, its guide surface 411a, 411b will be transverse to the guide surface 211, 311, and/or the opposing surface 203a, of the applicator 200, 300. Hence, the guide surface 411a, 411b, may be aligned against one edge of the panel, wherein the applicator 200, 300 with its strip positioned therein at a predefined location, may be aligned relative a corner and another, transverse, edge of the panel 3. Hence, accurate alignment of the strips is provided for. In some embodiments, the recesses 428, 428 are provided in the applicators 200, 300, and the alignment members 227, 337 in the alignment tool. A mix of a recess and an alignment member for the respective applicator may also be provided in the alignment tool.

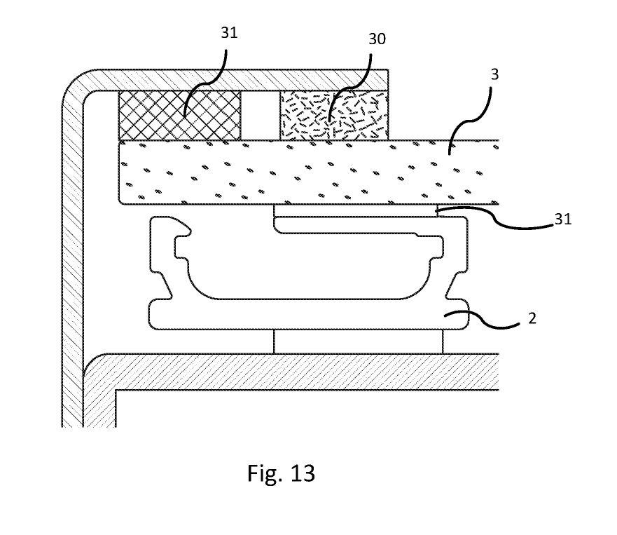

FIG. 13 illustrates an arrangement of optical components using the tools of the embodiments described herein. The component 2 is arranged in one side of the panel 3. A first strip 30, such as a sealing strip, and a second strip 31, such as a strip for directing a light signal, is arranged on a second opposite side of the panel 3. The second strip 31 is arranged closer to the edge of the panel 3 than the first strip 30 using applicator 200. The first strip 30 is applied closer to the centre of the panel 3 than the second strip 31 using the applicator 300. Multiple strips and components may be applied around the perimeter of the panel 3, such as starting at one corner and then going a circle in a single direction, e.g. first strips and a first component applied along a first edge starting at the bottom left corner, second strips and a second component applied along a second edge starting at the bottom right corner, third strips and a third component along a third edge applied starting at the top right corner, and fourth strips and a fourth component along a fourth edge applied starting at the top left corner. The component 2 may be applied using an adhesive 33.

The assembly tool 1, 101, and the applicator 200, 300 can be provided as CAD models that may be produced by rapid prototyping technology, such as 3D printing in plastics or other material. This provides for rapid and flexible manufacturing where the assembly tool 1, 101, and/or the applicator 200, 300 are needed rather than shipping the products. Various dimensions and markers may be provided on the tools, which may be used to verify the accuracy of the tools when produced. Hence, the tools may be produced wherever components are applied to panels. If the tool is worn or lost, a new tool may simply be produced rather than a new ordered. This provides for a flexible and reliable assembly process, and the production process stopped simply because the tools are missing.

It should also be appreciated that features disclosed in the foregoing description, and/or in the foregoing drawings and/or following claims both separately and in any combination thereof, be material for realizing the present invention in diverse forms thereof. When used in the following claims, the terms “comprise”, “include”, “have” and their conjugates mean, “including but not limited to”.

The present invention has been described above with reference to specific embodiments. However, other embodiments than the above described are equally possible within the scope of the invention. Different method steps than those described above may be provided within the scope of the invention. The different features and steps of the invention may be combined in other combinations than those described. The scope of the invention is only limited by the appended patent claims.

1. An assembly tool for mounting at least one component of a touch-sensing system to a panel, comprising:
at least one fixture portion with a first side wall and at least a second side wall extending in a longitudinal direction of the assembly tool and being configured to hold the component in the fixture portion, wherein
the first side wall extends in a first transverse direction of the assembly tool further than the second side wall extends in the first transverse direction and has a guide surface configured to abut an edge of the panel and guide the position of the assembly tool relative to the edge of the panel.

2. The assembly tool according to claim 1, wherein at least one of the first side wall and the second side wall comprises at least one connecting element that extends differently in a second transverse direction of the assembly tool than the at least one of the first side wall and the second side wall, wherein the connecting element preferably comprises at least one of a protrusion and a recess of a snap-fit connection.

3. The assembly tool according to claim 1, comprising:
a bottom wall extending in a second transverse direction of the assembly tool and between the first side wall and the second side wall, and
a support structure attached to the second side wall and extending in the second transverse direction and substantially parallel to the bottom wall, the support structure being configured to abut a top surface of the panel.

4. The assembly tool according to claim 3, further comprising a compressible cushion attached to the support structure and configured to abut the top surface of the panel.

5. The assembly tool according to claim 1, wherein the first side wall is substantially planar and provided in a single plane in the first transverse direction.

6. The assembly tool according to claim 1, wherein at least one of the first side wall and the second side wall comprise a slot.

7. The assembly tool according to claim 1, comprising a third side wall extending in the first transverse direction and substantially perpendicularly to the first side wall, wherein the third side wall is arranged at a distance from an end of the fixture portion.

8. The assembly tool according to claim 7, wherein the assembly tool is double sided and the at least one fixture portion includes a first fixture portion and a second fixture portion on each side of the first side wall, and further comprises:
a fourth side wall corresponding to the third side wall, wherein
the third side wall is arranged at a first distance from an end of the first fixture portion and the fourth side wall is arranged at a second distance from an end of the second fixture portion and at the same side of the assembly tool as the third side wall.

9. A kit comprising the assembly tool of claim 1 and a carrier for at least one component of a touch-sensing system, wherein the carrier comprises:
an elongated profile having a first substantially flat surface for receiving an adhesive and a second surface spaced apart from the first surface, and
a space between the first substantially flat surface and the second surface, wherein
the first surface comprises at least one slot.

10. The kit according to claim 9, wherein the carrier comprises at least one of a protrusion and a recess in opposing side surfaces extending between the first substantially flat surface and the second surface, and the assembly tool comprises the other of a protrusion and a recess in the first wall and the second wall, which are arranged to mate with the at least one of a protrusion and a recess in the first substantially flat surface and the second surface of the carrier.

11. A kit comprising the assembly tool of claim 1 and an applicator for applying a plastic strip to a surface of a panel, the applicator comprising a guide with opposing surfaces and at least one transverse surface extending therebetween, wherein at least one slot is provided in the transverse surface.

12. The kit according to claim 11, wherein the said at least one slot in the transverse surface of the applicator includes a first slot and a second slot, the first slot and the second slot being separated by a distance in the longitudinal direction of the applicator, the first slot forming an exit of a first channel for the plastic strip, and the second slot providing an exit of a second channel for a cover over an adhesive of the plastic strip, wherein an entry to the first channel and an entry to the second channel are provided at one end of the applicator, and wherein the entries are separated by a distance forming an edge for separating the cover from the plastic strip.

13. The kit according to claim 11, wherein the applicator comprises at least one flexible member provided in at least one of the opposing surfaces of the applicator, wherein the flexible member extends into the space between the opposing surfaces to apply a pressure to the plastic strip when received therein.

14. The kit according to claim 11, the applicator comprises a groove on a surface opposite to the transverse surface, wherein the groove is configured for receiving at least one finger.

15. The kit according to claim 11, the applicator comprises a holder for a roll of the plastic strip.
